(19) United States
(12) Patent Application Publication
(10) Pub. No.: US 2022/0080446 A1
(43) Pub. Date: Mar. 17, 2022

(54) Sprinkler Head Wedge Device

(71) Applicant: Irrigation Advantage, LLC, Fort Myers, FL (US)

(72) Inventors: John Gargano, Ave Marie, FL (US); Jeff Darragh, Fort Myers, FL (US)

(21) Appl. No.: 17/343,180

(22) Filed: Jun. 9, 2021

Related U.S. Application Data
(60) Provisional application No. 63/079,122, filed on Sep. 16, 2020.

(51) Int. Cl. B05B 15/50; B05B 15/74

(52) U.S. Cl. CPC B05B 15/50; B05B 15/74

(57) ABSTRACT

A wedge device to selectively maintain a riser of a pop-up sprinkler head in a raised position, and a method of using the wedge device, the wedge device including an elongated member formed in a curved configuration between opposite sides of the elongated member to approximate a cylindrical outer surface of the riser, and a gripping member extending from proximate a top end of the elongated member to facilitate gripping of the wedge device, wherein a bottom end of the elongated member is configured to be inserted between the riser and a wiper seal of the pop-up sprinkler so as to wedge the riser in the raised position.

### CROSS-REFERENCE TO RELATED APPLICATIONS

This application claims the benefit of U.S. Provisional Patent Application Ser. No. 63/079,122, filed on Sep. 16, 2020, which is incorporated herein in its entirety by reference.

### FIELD OF INVENTION

The present general inventive concept relates to sprinkler system maintenance and repair, and, more particularly, to a device to selectively maintain a riser of a sprinkler head in a raised position for maintenance or repair.

### BACKGROUND

Lawn irrigation systems, or sprinkler systems, include a plurality of sprinkler heads, each of which incorporate a riser that is slidably received within a body of the sprinkler head. When water enters the inlet of the sprinkler head connected in fluid communication with an irrigation system supply hose, the nozzle mounted at the distal end of the riser extends upwardly above the ground level and commences spraying water over the proximate area. The riser with the nozzle carried at its distal end is slidably received within the body of the sprinkler head with the outer surface of the riser sliding within a circular wiper seal mounted in the cap of the nozzle head. However, because the risers are typically biased so as to stay retracted inside the sprinkler head body when not being supplied with water, it is inconvenient and difficult to perform maintenance, preventative or otherwise, on the risers. Irrigation technicians and landscape service providers do not have a way to keep the riser of a spray irrigation head from going back down into the sprinkler head body when the water is not turned off, which keeps them from being able to fix issues with the nozzle in a clean and efficient manner. Therefore, it would be desirable to have a convenient way to secure the risers in an extended or raised position so that a worker can more conveniently access the nozzle and riser.

### BRIEF SUMMARY

According to various example embodiments of the present general inventive concept, a wedge device is provided that is configured to be inserted between the riser and wiper seal of a pop-up sprinkler head in a lawn irrigation system. The wedge device keeps the riser from sliding back into the body of the sprinkler head, and facilitates repair of the nozzle and/or riser when it is clogged or needs maintenance or replacement.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a wedge device to selectively maintain a riser of a pop-up sprinkler head in a raised position, the wedge device including an elongated member formed in a curved configuration between opposite sides of the elongated member to approximate a cylindrical outer surface of the riser, and a gripping member extending from proximate a top end of the elongated member to facilitate gripping of the wedge device, wherein a bottom end of the elongated member is configured to be inserted between the riser and a wiper seal of the pop-up sprinkler so as to wedge the riser in the raised position.

The foregoing and/or other aspects and advantages of the present general inventive concept may also be achieved by providing an irrigation system including a water supply conduit, one or more pop-up sprinkler heads connected to the water supply conduit, the one or more pop-up sprinkler heads including a riser configured to extend upward when water is supplied thereto, a nozzle provided a top of each riser to spray the water onto an area around the respective one or more pop-up sprinkler heads, and one or more wedge devices to be selectively inserted between the riser and a wiper seal receiving the riser to maintain the riser in a raised position, the wedge device including an elongated member formed in a curved configuration between opposite sides of the elongated member to approximate a cylindrical outer surface of the riser, and a gripping member extending from proximate a top end of the elongated member to facilitate gripping of the wedge device, wherein a bottom end of the elongated member is configured to be inserted between the riser and a wiper seal of the pop-up sprinkler so as to wedge the riser in the raised position.

The foregoing and/or other aspects and advantages of the present general inventive concept may also be achieved by providing

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIGS. 1A-C illustrate various views of components of a conventional lawn sprinkler system;

FIG. 2 illustrates a wedge device used with the lawn sprinkler system of FIGS. 1A-C according to an example embodiment of the present general inventive concept;

FIGS. 3A-D illustrate various views of a wedge device according to example embodiments of the present general inventive concept;

FIGS. 4A-C illustrate various views of a sprinkler head riser being maintained in a raised position by the wedge device of FIG. 2;

FIGS. 5A-C illustrate various views of a wedge device according to another example embodiment of the present general inventive concept; and

FIG. 6 is a flowchart illustrating a method of using the wedge device according to an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a wedge device is provided that is configured to be inserted between the riser and wiper seal of a pop-up sprinkler head in a lawn irrigation system. The wedge device keeps the riser from sliding back into the body of the sprinkler head, and facilitates repair of the nozzle and/or riser when it is clogged or needs maintenance or replacement. A wedge device constructed in accordance with various features of the present general inventive concept may be configured such that the nozzle can be selectively positioned above the cap of the body even when water is not flowing into the inlet from the supply hose. In such an arrangement, a repairman can gain ready access to the nozzle or riser in the event it is clogged or needs to be replaced or upgraded. Thus, the wedge device enables a repairman to work on the sprinkler head with the riser in the extended position even if water is not flowing through the inlet. Moreover, if desired, the wedge device can be positioned for maintaining the riser in an upright position when water is flowing to selectively increase the amount of irrigation occasioned proximate the sprinkler head having the nozzle fixed in an upright position.

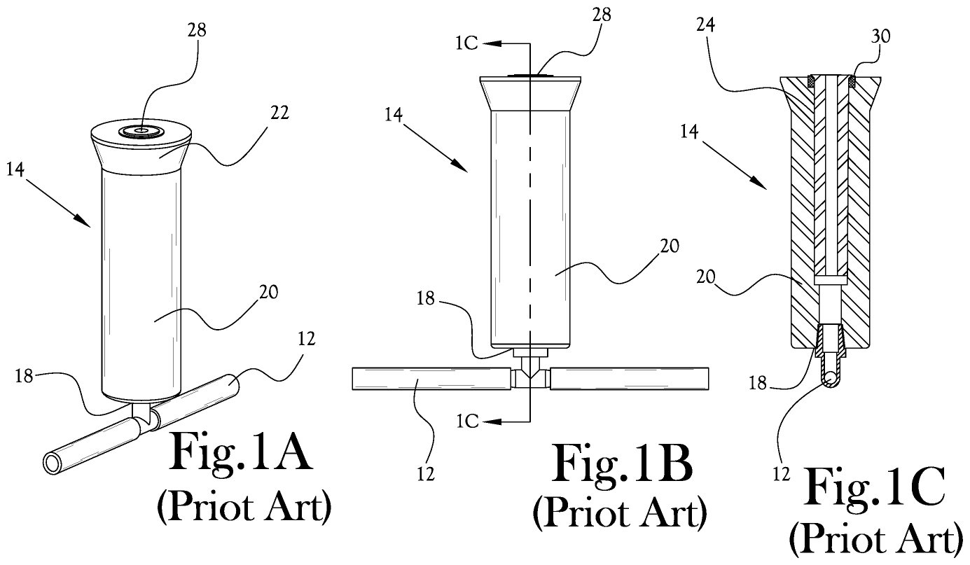

FIGS. 1A-C illustrate various views of components of a conventional lawn sprinkler system. FIG. 1A illustrates a perspective view of a conventional sprinkler head 14 connected by an inlet 18 to a water supply hose 12 that provides water to the sprinkler head 14. FIG. 1B illustrates a side view of the sprinkler head 14, and FIG. 1C illustrates a cross-sectional view of the sprinkler head 14 from the perspective of the line 1C shown in FIG. 1B. As illustrated in FIGS. 1A-C, the sprinkler head 14 includes a sprinkler head body 20 with the inlet 18 provided at a bottom thereof, and a cap 22 provided at a top of the body 20. The body 20 defines an elongated internal opening 24 which extends from the inlet 18 through the cap 22, and receives a riser 26 that is provided at a distal end thereof with a nozzle 28 through which water exits the sprinkler head 14 to define a spray shown which serves to irrigate the surrounding area, which may include grass. The riser 26 is slidably received within the opening 24 and extends through a wiper seal 30 provided about a perimeter of the top of the opening 24. The wiper seal 30 slidably engages the riser 26 as it is lowered into, and raised out of, the opening 24 when water is supplied or cut off from the sprinkler head 14. When the nozzle 28 or riser 26 is clogged and needs to be repaired, switched out, or upgraded, it is desirable to be able to selectively position the riser 26, and therefore the nozzle 28, in an extended or raised position, as if water is being sprayed from the sprinkler head 14, even if water is not passing through the sprinkler head 14 onto the surrounding ground.

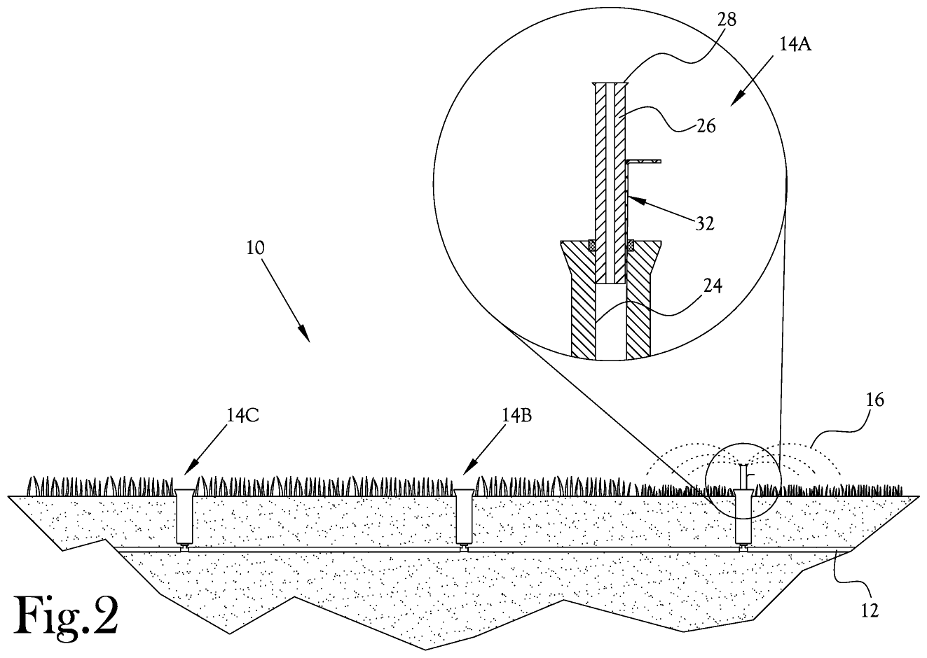

FIG. 2 illustrates a wedge device used with the lawn sprinkler system of FIGS. 1A-C according to an example embodiment of the present general inventive concept. As illustrated in FIG. 2, a lawn irrigation system 10 typically has one or more supply hoses 12 that are connected at one end to a conventional water supply (not shown), and that supply water to a plurality of sprinkler heads, noted in FIG. 2 as 14A-C. Normally the supply hose 12 is buried a few inches below the surface of the ground as shown in FIG. 2, and the plurality of pop-up sprinkler heads 14A, 14B, and 14C are connected to the supply hose 12 at spaced intervals to facilitate a desired irrigation spray of water as shown at 16 in FIG. 2. As previously described, water from the supply hose 12 forces the risers 26 of the sprinkler heads 14A-C to extend to a raised position, and the water if sprayed our of the nozzles 28 at the top of the risers 26. The risers 26 may be biased downward to return to their lowered or retracted positions, or in some cases return to their lowered positions by the force of gravity. Thus, to facilitate convenient access to the risers 26 and/or nozzles 28 for maintenance or replacement, a wedge device 32 is provided that is configured to at least partially slip between the riser 26 and the wiper seal 30 and/or the wall of the elongated internal opening 24 to wedge the riser 26 in the raised position even when water is not being supplied to the sprinkler head 14. As illustrated in the enlarged section of FIG. 2, the wedge device 32 has been inserted between the wiper seal 30 and the riser 26 of sprinkler head 14A, thus pressing the riser 26 toward the opposite side of the elongated internal opening 24 and forming a friction fit so that the riser stays in the raised position.

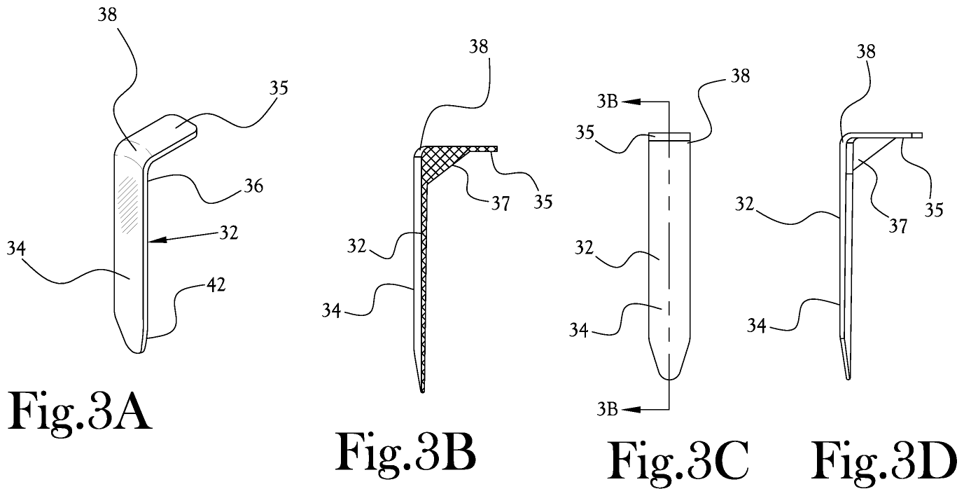

FIGS. 3A-D illustrate various views of a wedge device according to example embodiments of the present general inventive concept. FIG. 3A illustrates a perspective view of the wedge device 32, FIG. 3B illustrates a cross-sectional view of the wedge device 32 along with a gusset 37 provided as described herein, FIG. 3C illustrates a front view of the wedge device 32, and FIG. 3D illustrates a side view of the wedge device 32, again with the gusset 37 shown in FIG. 3B. Although FIGS. 3B and 3D illustrate a wedge device with the optional gusset 37 according to an example embodiment of the present general inventive concept, the wedge device is referred to by the same identifier 32 throughout these drawings as the features other than the gusset 37 may be substantially similar in those two embodiments. As illustrated, the wedge device 32 is configured with an elongated member 34 having a first or top end portion 38, and a second or bottom end portion 42. The elongated member 34 may be curved from side to side along at least a portion of the elongated member 34 to approximate the cylindrical outer surface of the riser 26, and/or the cylindrical wall of the elongated internal opening 24 of the sprinkler head body 20. The top end portion 38 of the wedge device 32 may be provided with a gripping member 35 which extends outwardly from the longitudinal axis of the elongated member 34 to facilitate gripping and handling of the wedge device 32. The gripping member 35 may also be provided with a curve similar to the elongated member 34, which may be continued from the elongated member 34, to facilitate a thumb or other finger of a user more securely when gripping the wedge device 32. In various example embodiments the gripping member 35 may be provided with a roughened or patterned surface on the top and/or bottom of the gripping member to facilitate more secure handling of the wedge device 32. As previously noted, the wedge device 32 may be provided with the gusset 37 to provide strength and support between the top end portion 38 of the elongated member 34 and the gripping member 35. A single gusset 37 is illustrated as being provided proximate a middle of the top end portion 38 and the gripping member 35, but in various other example embodiments the gusset may be provided at one or both edges, with a width approaching that of the elongated member 34, and so on.

As illustrated in FIGS. 3A-3D, the bottom end portion 42 of the elongated member 34 may be tapered and proportioned so as to be received between the outer surface of the riser 26 and the wiper seal 30. As such, the tapered end of the wedge device 32 can be more easily slipped between the wiper seal 30 and the riser 26, and as the wedge device is pushed in the increasingly thicker portion of the elongated member causes a friction or forced fit between the riser 26 and the wiper seal 30 to selectively secure the riser 26 in an extended position. This facilitates maintaining the riser 26 in this extended position to enable a repairman ready access to the riser 26 and nozzle 28 in the event work thereon is needed. As illustrated in FIGS. 3A-3D, the bottom end portion 42 of the elongated member 34 may be tapered not only in thickness, but also in width. Thus, both tapered dimensions may provide assistance with insertion of the wedge device 32 into the sprinkler head 14. Various other example embodiments of the present general inventive concept may omit either of both of the tapered dimensions. Various typical sprinkler systems are configured with sprinkler heads having a nozzle that can be easily gripped to raise the riser manually. In other systems in which the nozzle cannot be easily gripped, the tapered end of various example embodiments of the wedge device can also be used to pry the nozzle up far enough for the user to grip it before inserting the wedge device into the sprinkler head.

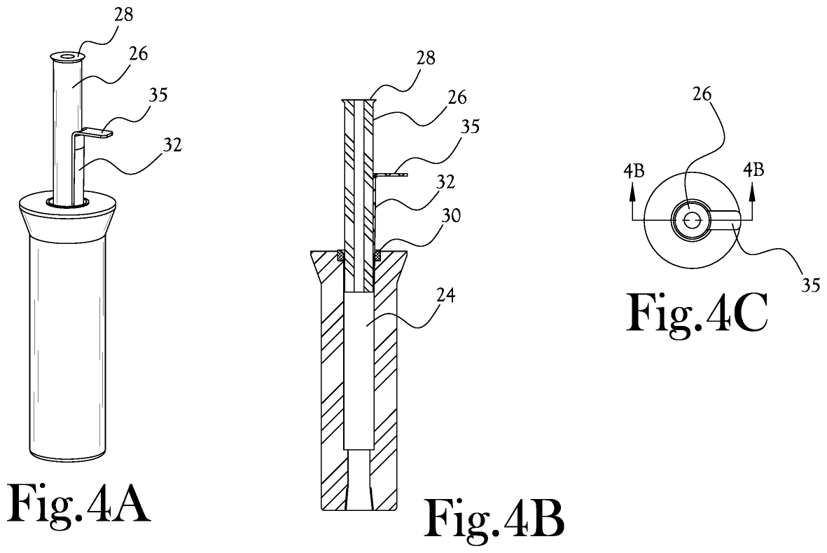

FIGS. 4A-C illustrate various views of a sprinkler head riser being maintained in a raised position by the wedge device of FIG. 2. FIG. 4A illustrates a perspective view of the riser 26 being secured in the raised position by the wedge device 32, FIGS. 4B-C respectively illustrate a cross-sectional and top views of this arrangement. As illustrated in FIGS. 4A-C, a user has inserted the bottom end portion 42 of the wedge device 32 in between the wiper seal 30 and the riser 26, and pushed the bottom end portion 42 down further into the elongated internal opening 24 of the sprinkler head 14 so as to wedge the riser 26 into the raised position.

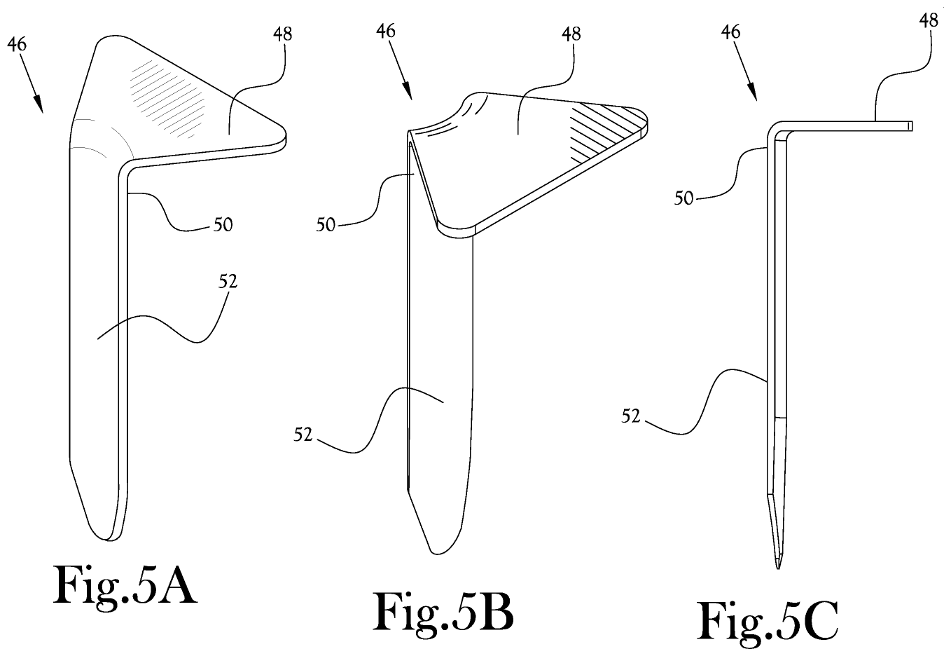

FIGS. 5A-C illustrate various views of a wedge device according to another example embodiment of the present general inventive concept. FIG. 5A illustrates a perspective view of a wedge device 46 having a gripping member 48 that flares out, or increases in width, as it extends away from a top end portion 50 of the elongated member 52. Such a gripping member 48 provides more surface grip for a user to more conveniently use the wedge device 46. Although not gusset is illustrated in these figures, it will be understood that various example embodiments of all of the wedge devices described herein may include one or more gussets to provide support between the gripping member and elongated members of the wedge devices.

From the previous description, it will be recognized by those skilled in the art that a wedge device is constructed for selectively maintaining the riser having a nozzle at its distant end in an extended position with respect to the body of a pop-up sprinkler to facilitate nozzle or riser repair as needed. Moreover, if desired, the wedge device can be positioned for maintaining the riser in an upright position when water is flowing to selectively increase the amount of irrigation occasioned proximate the sprinkler head having the nozzle fixed in an upright position as is shown in FIG. 2 with the grass near the extended riser is of lesser height and needs additional irrigation.

Various example embodiments of the present general inventive concept may provide a wedge device configured to be inserted between the riser and wiper seal of most any “spray” or “pop-up” irrigation head, which provides a wedge to keep the riser from going back down into the body of the head. Such a device is beneficial when a nozzle or riser is clogged and needs to be worked on, when a whole zone needs to be flushed, when nozzles are switched out or upgraded, when any work needs to be done to the nozzle of the irrigation head, etc. The wedge device allows an irrigation technician to stay dry while working on a nozzle, and keeps debris from back flowing into the body of the head by keeping the riser above the grade even when the water to the zone is turned off. The wedge device increases the efficiency of fixing clogged nozzles and zones, and keeps additional debris from getting inside the riser of the body of the head. With the wedge device of various example embodiments of the present general inventive concept, the technician can turn on a zone, and then wedge each riser that has a clogged or bad nozzle. Afterwards, the technician can turn off the zone and each wedged riser will still be out above grade. The technician can also manually raise the risers without using the water, and wedge them in the raised position. Thus, the technician can work on and remove the nozzles without getting wet. The nozzles can be removed, and the technician can turn the zone back on to flush the riser, which could still have debris in it. After flushing the riser and line the technician can put the nozzle back on the riser and remove the wedge device. The wedge device may be formed with a flexible yet durable plastic. Various example embodiments of the present general inventive concept may provide a wedge device with a universal end that will work on any size pop-up sprinkler head. For example, the universal end may work on any sprinkler head from a 2-inch size to a 12-inch size.

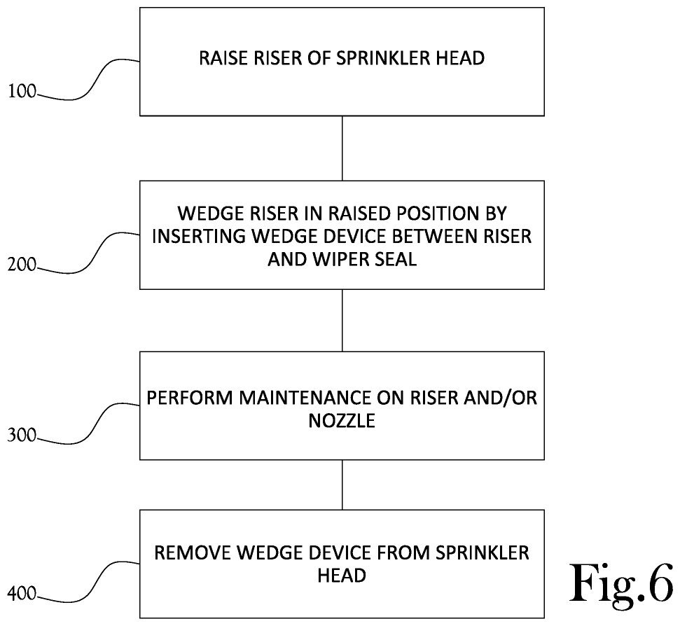

FIG. 6 is a flowchart illustrating a method of using the wedge device according to an example embodiment of the present general inventive concept. In operation 100 a user raises the riser of a sprinkler head by manually pulling up on the nozzle. In operation 200, while the holding the nozzle in the raised position, the user inserts the bottom end of the wedge device between the riser and wiper seal, and further inserts the wedge device into the sprinkler head until the riser is wedged into place and stays in the raised position without being held by the user. In operation 300, the user performs any desired maintenance, upgrade, replacement, etc., of the riser and/or nozzle. In operation 400, the user removes the wedge device from the sprinkler head, and allows the riser to move back into the sprinkler head.

A wedge device is provided for selectively maintaining the riser having a nozzle at its distal end in an extended position with respect to the body of a pop-up sprinkler head. The wedge device is an elongated member that is curved to approximate the cylindrical outer surface of the riser and includes a first end portion that includes a gripping member which extends outwardly from its longitudinal axis to facilitate gripping and handling of the wedge device. A second end portion at the opposite end of the elongated member is preferably tapered and proportioned for being received between the outer surface of the riser and a wiper seal for forming a force fit between the riser and the seal to selectively secure the riser in an extended position to facilitate repair even when water is not flowing into the sprinkler head through the supply hose.

Various example embodiments of the present general inventive concept may provide a wedge device to selectively maintain a riser of a pop-up sprinkler head in a raised position, the wedge device including an elongated member formed in a curved configuration between opposite sides of the elongated member to approximate a cylindrical outer surface of the riser, and a gripping member extending from proximate a top end of the elongated member to facilitate gripping of the wedge device, wherein a bottom end of the elongated member is configured to be inserted between the riser and a wiper seal of the pop-up sprinkler so as to wedge the riser in the raised position. The gripping member may extend outwardly from a longitudinal axis of the elongated member. The gripping member may extend substantially perpendicular to the longitudinal axis of the elongated member. At least a portion of the gripping member may be wider than the elongated member. The gripping member may flare outward along a length extending away from the elongated member. The wedge device may further include a gusset configured to extend between a portion of a lower surface of the gripping member and a portion of the elongated member proximate the top end. The gusset may be configured with a continuous surface in a bend between the elongated member and the gripping member. The bottom end of the elongated member may be configured with a tapered portion to be inserted between the riser and the wiper seal of the pop-up sprinkler. The tapered portion of the elongated member may be configured to have a thinner thickness than a portion of the elongated member above the bottom end. The tapered portion of the elongated member may be configured to have a thinner width than a portion of the elongated member above the bottom end. The bottom end of the elongated member may be configured to form a friction fit between the riser and a wiper seal of the pop-up sprinkler to prevent the riser from lowering into the sprinkler head.

Various example embodiments of the present general inventive concept may provide an irrigation system including a water supply conduit, one or more pop-up sprinkler heads connected to the water supply conduit, the one or more pop-up sprinkler heads including a riser configured to extend upward when water is supplied thereto, a nozzle provided a top of each riser to spray the water onto an area around the respective one or more pop-up sprinkler heads, and one or more wedge devices to be selectively inserted between the riser and a wiper seal receiving the riser to maintain the riser in a raised position, the wedge device including an elongated member formed in a curved configuration between opposite sides of the elongated member to approximate a cylindrical outer surface of the riser, and a gripping member extending from proximate a top end of the elongated member to facilitate gripping of the wedge device, wherein a bottom end of the elongated member is configured to be inserted between the riser and a wiper seal of the pop-up sprinkler so as to wedge the riser in the raised position. The wedge bottom end of the elongated member may be configured with a tapered portion to be inserted between the riser and the wiper seal of the pop-up sprinkler head. The tapered portion of the elongated member may be configured to have a thinner thickness than a portion of the elongated member above the bottom end. The tapered portion of the elongated member may be configured to have a thinner width than a portion of the elongated member above the bottom end. The bottom end of the elongated member may be configured to form a friction fit between the riser and a wiper seal of the pop-up sprinkler to prevent the riser from lowering into the sprinkler head.

Various example embodiments of the present general inventive concept may provide a method of selectively securing a riser of a pop-up sprinkler head in a raised position, the method including raising a riser of the sprinkler head that moves through a wiper seal, wedging a wedge device between the riser and the wiper seal to wedge the riser in the raised position so that the riser and a nozzle at a top of the riser is maintained above the wiper seal, and removing the wedge device from the sprinkler head after performing riser maintenance to allow the riser to retract into a lowered position in the sprinkler head.

Various example embodiments of the present general inventive concept may provide a wedge device for selectively maintaining the riser having a nozzle at its distal end in an extended position with respect to the body of a pop-up sprinkler head having a cap positioned proximate ground level, said head further including a wiper seal carried in the cap for slidably receiving and wiping the riser as the nozzle slidably extends from and is received within the interior of the body, said wedge device including an elongated member curved to approximate the cylindrical outer surface of the riser, a first end portion of said elongated member including a gripping member extending outwardly from the longitudinal axis of elongated member to facilitate gripping said wedge device, and a second end portion of said elongated member proportioned for being received between the outer surface of the riser and the wiper seal, for forming a force fit between said riser and said seal to selectively secure the riser in an extended position as desired, as when the nozzle or riser is clogged and needs repair, when work needs to be performed on the nozzle of the irrigation head, or the like. The first end portion of the device may include a gripping member that extends substantially perpendicular to the elongated member. The gripping member may extend substantially perpendicular to the elongated member and may be flared into a width greater than the elongated member to facilitate gripping the wedge device. The gripping member at the first end portion of the device may be reinforced with a gusset at the location proximate where the gripping member and elongated member are connected.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A wedge device to selectively maintain a riser of a pop-up sprinkler head in a raised position, the wedge device comprising:
an elongated member formed in a curved configuration between opposite sides of the elongated member to approximate a cylindrical outer surface of the riser; and
a gripping member extending from proximate a top end of the elongated member to facilitate gripping of the wedge device;
wherein a bottom end of the elongated member is configured to be inserted between the riser and a wiper seal of the pop-up sprinkler so as to wedge the riser in the raised position.

2. The wedge device of claim 1, wherein the gripping member extends outwardly from a longitudinal axis of the elongated member.

3. The wedge device of claim 2, wherein the gripping member extends substantially perpendicular to the longitudinal axis of the elongated member.

4. The wedge device of claim 1, wherein at least a portion of the gripping member is wider than the elongated member.

5. The wedge device of claim 4, wherein the gripping member flares outward along a length extending away from the elongated member.

6. The wedge device of claim 1, further comprising a gusset configured to extend between a portion of a lower surface of the gripping member and a portion of the elongated member proximate the top end.

7. The wedge device of claim 6, wherein the gusset is configured with a continuous surface in a bend between the elongated member and the gripping member.

8. The wedge device of claim 1, wherein the bottom end of the elongated member is configured with a tapered portion to be inserted between the riser and the wiper seal of the pop-up sprinkler.

9. The wedge device of claim 8, wherein the tapered portion of the elongated member is configured to have a thinner thickness than a portion of the elongated member above the bottom end.

10. The wedge device of claim 8, wherein the tapered portion of the elongated member is configured to have a thinner width than a portion of the elongated member above the bottom end.

11. The wedge device of claim 1, wherein the bottom end of the elongated member is configured to form a friction fit between the riser and a wiper seal of the pop-up sprinkler to prevent the riser from lowering into the sprinkler head.

12. An irrigation system comprising:
a water supply conduit;
one or more pop-up sprinkler heads connected to the water supply conduit, the one or more pop-up sprinkler heads including a riser configured to extend upward when water is supplied thereto;
a nozzle provided a top of each riser to spray the water onto an area around the respective one or more pop-up sprinkler heads; and
one or more wedge devices to be selectively inserted between the riser and a wiper seal receiving the riser to maintain the riser in a raised position, the wedge device comprising:
an elongated member formed in a curved configuration between opposite sides of the elongated member to approximate a cylindrical outer surface of the riser; and
a gripping member extending from proximate a top end of the elongated member to facilitate gripping of the wedge device;
wherein a bottom end of the elongated member is configured to be inserted between the riser and a wiper seal of the pop-up sprinkler so as to wedge the riser in the raised position.

13. The wedge device of claim 12, wherein the bottom end of the elongated member is configured with a tapered portion to be inserted between the riser and the wiper seal of the pop-up sprinkler head.

14. The wedge device of claim 13, wherein the tapered portion of the elongated member is configured to have a thinner thickness than a portion of the elongated member above the bottom end.

15. The wedge device of claim 13, wherein the tapered portion of the elongated member is configured to have a thinner width than a portion of the elongated member above the bottom end.

16. The wedge device of claim 2, wherein the bottom end of the elongated member is configured to form a friction fit between the riser and a wiper seal of the pop-up sprinkler to prevent the riser from lowering into the sprinkler head.

17. A method of selectively securing a riser of a pop-up sprinkler head in a raised position, the method comprising:
raising a riser of the sprinkler head that moves through a wiper seal;
wedging a wedge device between the riser and the wiper seal to wedge the riser in the raised position so that the riser and a nozzle at a top of the riser is maintained above the wiper seal; and
removing the wedge device from the sprinkler head after performing riser maintenance to allow the riser to retract into a lowered position in the sprinkler head.
